(19) United States
(12) Patent Application Publication
(10) Pub. No.: US 2014/0244284 A1
(43) Pub. Date: Aug. 28, 2014

(54) COMMUNICATION OF MEDICAL CLAIMS

(71) Applicant: Complete Consent, LLC, Savannah, GA (US)

(72) Inventor: Sidney P. Smith, Savannah, GA (US)

(73) Assignee: Complete Consent, LLC, Savannah, GA (US)

(21) Appl. No.: 14/188,715

(22) Filed: Feb. 25, 2014

Related U.S. Application Data
(60) Provisional application No. 61/768,615, filed on Feb. 25, 2013.

(51) Int. Cl. G06F 19/00

(52) U.S. Cl. CPC G06F 19/328
USPC 705/2

(57) ABSTRACT

A system provides for documenting and sharing health insurance policy benefits that policy owners are actually receiving to assist patients and care providers in understanding policy coverages and costs. Health Benefits and prescription claims adjudicated by health insurance companies are documented, and adjudication results of the claims are recorded and stored. The adjudication results are organized by specific health insurance companies, and results are published for public access over a global network. Specific health insurance company benefits are continually updated with actual claim results providing real time benefit summaries for physicians to use when treating patients and for patients to compare insurance companies.

### CROSS-REFERENCES TO RELATED APPLICATIONS

This application claims the benefit of U.S. Provisional Patent Application Ser. No. 61/768,615, filed Feb. 25, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

Health insurance company benefits are managed by two divisions: one division controls the pharmacy benefits called the Pharmacy Benefits Manger (PBM), which may be a separate company from the health insurance company; and the surgery, medical, radiology and mental health benefits (health benefits) usually managed by the parent company or a separate company. Recording all claims adjudicated with a health insurance company, their PBM, or third party adjudicating company objectively documents the benefits patients are receiving from a specific insurance company. Because no health insurance company publishes a complete or current list of benefits, neither physicians nor patients know what health insurance benefits truly are for any insurance company at any given moment. It is only through a “trial and error method” that patients discover what their health insurance benefits are and what insurance companies will pay. How can a patient compare health insurance companies? How can a physician know what medicines are available to each patient or what steps or forms are needed to get the patient the medicines they need/deserve? How can a physician possibly keep track of the requirements or protocols for medical benefits of every insurance company with different benefits that always change? How can you grade the benefits for each health insurance company and compare each insurance company to a standard universally accepted benefit package?

Health insurance companies have contractual obligations to their customers for prescriptions and health benefits. The insurance companies are not required to define every benefit publicly, can change the benefits without public notification, alter the steps for patients to receive benefits, and have no external controls to make their actions public. The need for transparency is apparent. It would be beneficial if patients, physicians and hospitals could clearly understand each patient's health care benefits, and it would be beneficial to have a national consensus protocol for all health insurance companies to follow for best practices.

Prescription (Rx) benefits will be examined first. Pharmacy benefits for an insurance company are managed by the Pharmacy Benefits Manager (PBM). The PBM is usually a separate company contracted by the patient's insurance company. For example, United Health Care contracts with Medco Inc. to manage its customers' pharmacy benefits. The PBM manages the formulary or list of available medicines to a patient on the insurance plan, the cost to the patient for each medicine, and the steps required for physicians to follow to obtain each prescription (so-called “step edits”). The step edits are PBM specific protocols and forms outlining which medicine must be tried before other medicines. PBM formularies are often incomplete and change daily without any public notification about what medicines are available and what is the cost for a patient. With no requirement to publicly notify physicians or patients of the list of all medicines on the health plan, steps required for patients to receive medicines not on the preferred list, or provide expedient appeals processes, there is confusion experienced by patients and physicians about what medicines (Rxs) to prescribe. No one can daily predict what is “on the plan,” and what are the Rx costs for the patient. What is most surprising is that the cost of an Rx will not be disclosed to a patient until the process of adjudication has been completed. This adjudication process is basically a trial and error method where an Rx is written by the physician, the patient goes to the pharmacy to find out if his or her insurance will approve the Rx, what the cost will be, if another medicine is required, or if the physician must call or fax a form to the PBM for approval of an Rx.

Another outcome after an Rx adjudication is for the patients to be notified that a Prior Authorization (PA) form needs to be completed by the physician explaining why the patient needs the particular prescription, and that form needs to be sent to a specific address or email site at the insurance company. Upon receipt of the PA form at the insurance company, an evaluation is performed and a determination is made as to whether the information fulfills the requirements for use of the prescription. If there is a positive determination made, the information is returned to the pharmacy whereupon the patient's prescription is filled. If there is a negative determination made, the information is returned to the pharmacy, and the pharmacist calls the physician and lets him or her know the PA has been declined. At this point, the physician has the option of writing a letter of appeal. A letter of appeal is then written, submitted to the insurance company, an evaluation then occurs, and then the physician is notified as to whether the appeal has been denied or approved. If the appeal is approved, the patient receives the prescription. If the appeal is denied, the physician can write a subsequent letter or make a phone call to the medical director, and a third evaluation is performed as to whether the patient qualifies for the prescription.

Obviously, to anyone, the prescription procedure is cumbersome for the physician, the patient and the pharmacist. The only seeming benefactor to this procedure is the insurance company with the delay in payment for prescriptions.

These experiences are not unique and are a daily reality in all physicians' offices across the country and, in fact, the main reason physicians are currently closing their practices. Physicians simply do not have the time nor are they paid to work through the “trial and error process” required to find out which medicines are “on the plan,” find out Rx costs for a patient, or time to complete PA/Appeal forms for patients.

Also, like a patient's pharmacy benefits, health insurance companies are not legally required to publish their patients' health benefits. There is no public forum for patients, physicians, or health systems to access insurance companies' established protocols for health benefits, nor do health insurance companies make public their reimbursement for those benefits. Surprisingly, also like the previously discussed situation with a patient's medicines, physicians and patients do not know which procedures are approved until after they are requested or performed. Even with a prior approval letter from a health insurance company, the health insurance company does not “guarantee” payment.

### SUMMARY OF THE INVENTION

One way to solve the lack of transparency in the health insurance industry is to construct a software system that can trace each individual insurance company's actions for every patient through all adjudications of prescriptions and medical, surgical, radiological, and mental health benefits. The system described records the results of each adjudication function the specific health insurance company is currently performing called “Live Benefits.” The Live Benefits reflect ongoing insurance company actions of a specific health insurance company, which can be used to accurately assess an individual's expected benefits as a subscriber and enable physicianss to efficiently know how to treat each patient based on what is currently happening with a specific health insurance company.

The software interface may enable shared data about each insurance company's drug formulary, tier program, cost, and protocols with step edits and PAs. Also, data on all health benefits are shared including availability, cost, protocols and PAs. Physicians can use this data to integrate with insurance companies and order prescriptions or tests, follow protocols, file PA paperwork and monitor their efforts through the physician/patient interface.

The problem of comparing insurance companies may be solved by compiling each health insurance company's “Live Benefits” into a National Standard Benefits data bank. The system develops a National Standard Benefits Program offered by a majority of insurance companies based on the “Live Benefits” and compares each insurance company to that standard. Insurance companies are measured based on (1) accuracy of published benefits compared to Live Benefits, (2) PBM formulary list, (3) health benefits including medical, surgical, radiology and mental health benefits, (4) number of patients denied medicines, or medical, surgical, radiological, or mental health benefits and (5) comparison to the national standard benefits package (6), comparison of all step edits and protocols for insurance company benefits (7), and comparison of physician/patient assessments.

A software interface may be developed so that physicians can completely see all benefits available to a patient for all the patient's medical needs. No platform currently exists that enables patients and physicians to efficiently and proactively choose treatment options based on Live Benefits. With the novel interface, physicians can specifically inquire about what treatments are available based on the patient's Diagnosis ICD-10 code (International Code of Disease), a CPT code or current procedures terminology, or what medicines are available based on NDC number or National Drug Classification. Also, all insurance company specific step edits and protocols to follow are displayed and can be followed by the physician, patient, and health care system.

Patients can also use this interface to prospectively compare all benefits that an insurance company is currently providing and not simply advertising. Patients can prospectively follow a physician's activities with PA forms and insurance company interaction. Also, an external grading system is developed to compare the national standard benefits package to evaluate each plan.

The system and methodology of the preferred embodiments will enable physicianss, pharmaceutical companies, pharmacies, insurance companies, and patients to populate insurance company specific files describing the pharmacy benefits and health benefits of every insurance company based on actual health insurance company activities. This information will be used for patient care and for informed comparison of insurance companies. To improve care, a reporting system records all actions (claims and adjudicated prescriptions) of health insurance companies by the healthcare participants and shared among consumers. Collective documentation of actual health insurance company benefits will improve patient care. The system and methodology of the preferred embodiments will resolve the “trial and error” requirement through software based storage and sharing of imported data by physicians, pharmacies, PBMs and patients.

The described embodiments define a unique platform to compile data on every insurance company's adjudication activity and from that data establish national norms by which every insurance company can be graded. Additionally, the embodiments include unique interfaces for physicians to use as a tool with each patient to outline what benefits are currently available to a patient for the specific patient's insurance plan (“Live Benefits”) and to order prescriptions or services according to insurance company protocols. The interface also allows patients to compare insurance companies and allow objective quantitative evaluation of insurance plans.

In an exemplary embodiment, a method of documenting and sharing health insurance policy benefits includes the steps of (a) documenting health claims to be adjudicated by health insurance companies; (b) recording adjudication results of the health claims and storing the adjudication results; (c) organizing the adjudication results by health insurance company and by health insurance policy; and (d) publishing the organized adjudication results for public access over a global network.

Step (a) may be practiced by documenting medical procedure claims, and/or step (a) may be practiced by documenting prescription claims. With regard to prescriptions, step (c) may be further practiced by organizing the adjudication results by ailment and by drug and organizing all protocols, forms, and contact requirements.

Steps (a) and (b) may be practiced by enabling patient members to input the health claims and the adjudication results to the system server over the global network. Steps (a) and (b) may be practiced by enabling patients, physicians and the health insurance companies to input the health claims and the adjudication results to the system server over the global network. Step (b) may be practiced by recording approval or denial of the medical claim, step edits, protocols, whether prior authorization was obtained, cost, protocols, and formularies for prescriptions.

In one aspect, a consumer and/or physician grade for the health insurance companies and for the health insurance policies may be stored and published.

In another exemplary embodiment, a collaboration website is hosted by a server computer running a server program. The server computer executes the server program to perform the steps of (a) enabling individuals to input health claims adjudicated by health insurance companies; (b) documenting the health claims and recording adjudication results of the health claims for storage on the server computer; (c) a processor of the server computer organizing the adjudication results by health insurance company and by health insurance policy; and (d) the server computer publishing the organized adjudication results for public access over a global network.

In yet another exemplary embodiment, a computer system documents and shares health insurance policy benefits. The system includes a plurality of user computers each running a computer program that enables a patient or doctor to document health claims to be adjudicated by a health insurance company. A system server runs a server program, where the at least one user computer and the system server are interconnected by a computer network. The system server records adjudication results of the health claims and stores the adjudication results, and the system server organizes the adjudication results by health insurance company and by health insurance policy. The system server publishes the organized adjudication results for public access over a global network.

The system server may organize all benefits a specific insurance company is currently providing entitled Live Benefits. The Live Benefits may be organized as a tool/interface accessible by physicians to choose treatments available for any patient seen with a specific insurance company. The interface may publish protocols with PA forms and contacts. It also may enable physicianss to complete such forms on the interface and all physician work is communicated on a physician/patient dashboard. The interface used by physicians increases efficiency. The system server may organize all benefits continually through input by physicians, patients, and health insurance companies to provide the most up to date Live Benefits.

Physicians may access the physician/patient interface to follow ongoing PAs, appeal letters, or prescription adjudications. Patients may be able to access the interface to compare insurance company specific live benefits to other insurance companies based on a current activity and not marketing or website claims. Patients may access the interface to evaluate physician progress with PA applications, appeal letters, or prescriptions. The server may create a national standard protocol program that is unique in that it is a consensus of all insurance activity ongoing in the country. Each health insurance company may be graded based on their adherence to the national standard protocol program and is reported to all parties. By developing the national standard protocol program, the system may more efficiently improve patient access to care and correct insurance company corporate behavior detrimental to patients.

Other features of the preferred embodiments will be described:

The system server may enable physicians to query all treatment options available to a patient including prescriptions and health benefits based on a diagnosis;

The system server may enable physicians to choose a benefit for a patient based on cost;

The system server may enable physicians to choose which benefits are evidence based benefit options;

The system server may enable physicians to see step edits;

The system server may enable physicians to see the entire protocol with forms to be obtained for prescriptions and health benefits;

The system server may enable physicians to submit Rx and health benefits for adjudication;

The system server may enable physicians to record outcomes of claim adjudication;

The system server may enable physicians to counsel patients about benefit options;

The system server may enable physicians to grade health insurance companies.

The system server may enable patients to query all treatment options available including prescriptions and health benefits based on a diagnosis;

The system server may enable patients to choose a benefit based on cost;

The system server may enable patients to choose which benefits are evidence based benefit options;

The system server may enable patients to see step edits;

The system server may enable patients to see the entire protocol with forms to be obtained for prescriptions and health benefits;

The system server may enable patients to submit Rx and health benefits for adjudication;

The system server may enable patients to record outcomes of claim adjudication;

The system server may enable patients to be counseled about benefit options; and

The system server may enable patients to grade health insurance companies.

### BRIEF DESCRIPTION OF THE DRAWINGS

These and other aspects and advantages will be described in detail with reference to the accompanying drawings, in which:

FIG. 1 is a flow diagram of the documenting and sharing system/methodology of preferred embodiments; and

FIG. 2 is a flow diagram of the physician/patient interface;

FIG. 3 is a flow diagram of the Live Benefits and national standard benefits package; and

FIG. 4 is a detailed schematic of a computer system.

### DETAILED DESCRIPTION OF THE INVENTION

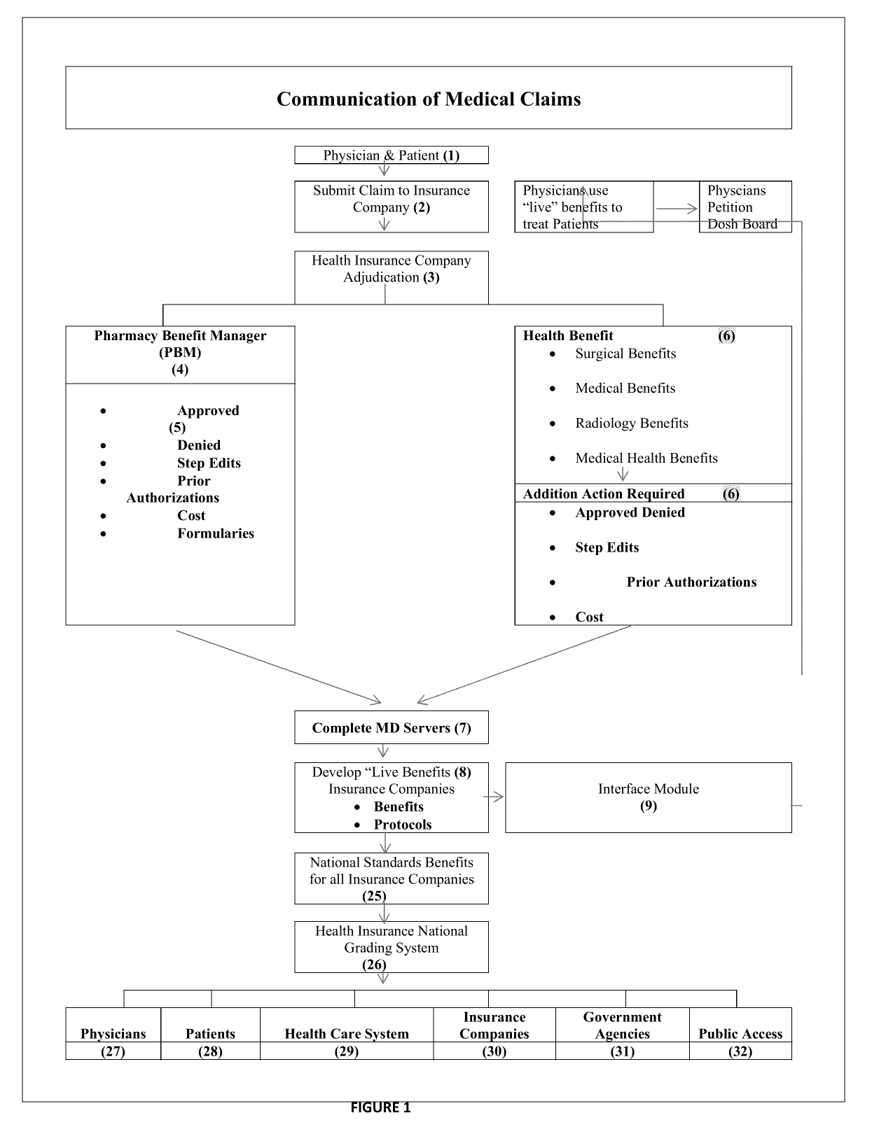

With reference to FIG. 1, after a physician-patient visit (1), a claim is submitted for either a prescription or health benefit or both (2). The claims are adjudicated by the health insurance company (3) and/or PBM (4), and the outcomes of the adjudication are recorded for pharmacy benefits (5) and health benefits (6) on a system server. The system server stores pharmacy and health benefit information including prescription, procedure approval, denial, step edits, prior authorizations, cost and formularies. The system server (7) organizes all PBM (5) and health benefits (6) in insurance company specific files to be accessed by physicians (27), patients (28), health care systems (29), insurance companies (30) government agencies (31), and the public (32).

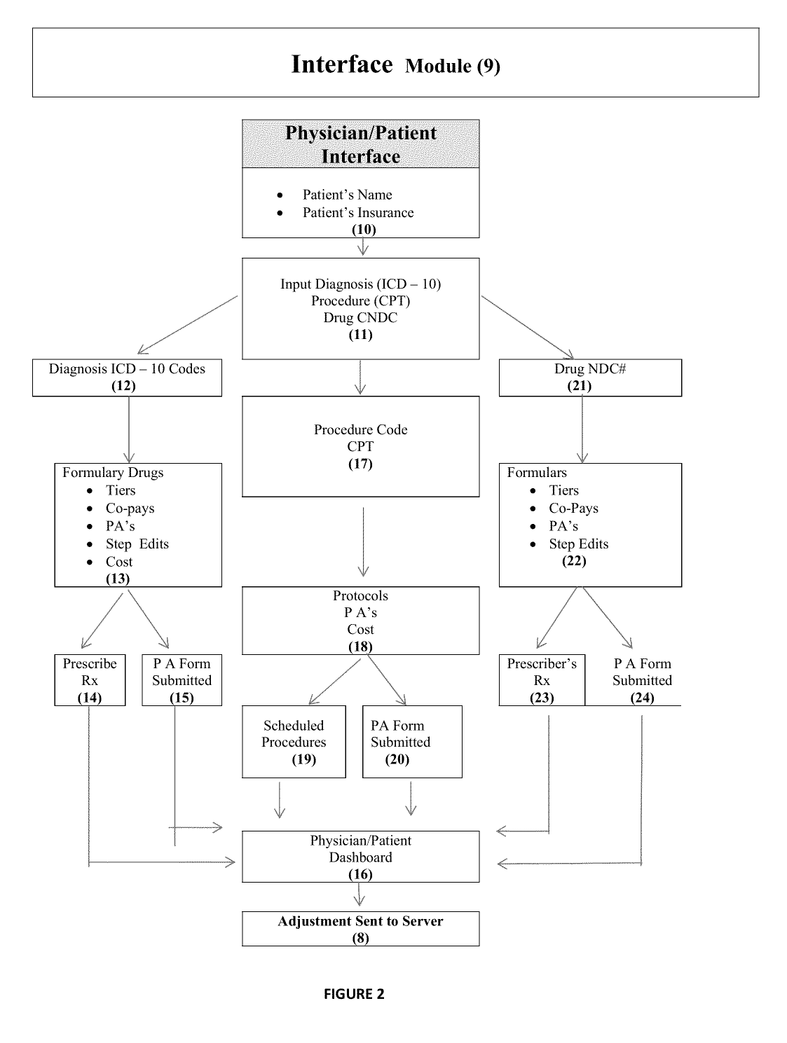

The servers develop “Live Benefits” for each insurance company through compiling all claims throughout the country (8). These Live Benefits reflect all activity for every insurance company and patient in the country. From this data, the servers develop a module where physicians and patients interface to (9) that can be used by physicians (10) (FIG. 2) to treat the next patient seen with a specific insurance company. This enables the physician and patient to know the entire benefits available to each patient and what protocols, step edits, PAs, formularies, and costs are required for each drug or health benefit.

The interface module (9) is accessible to patients to compare each insurance company's “Live Benefits” or what benefits individuals who currently have a specific health insurance policy are receiving.

The Physician/Patient interface (10) (FIG. 2) has the patient's name, patient's insurance, and space for the physician to place the desired benefit in question (11). The physician can enter a diagnosis (ICD-10 International Classification of Diseases) (12), a procedure (CPT code Current Procedural Terminology) (17), or a medicine NDC number (National Drug Classification Number) (21). The interface then compares the “Live Benefits” currently being provided by the specific insurance company for the diagnosis, procedure, or medicine. If the diagnosis (ICD-10) is entered (12), all the treatment options for the specific insurance company are displayed with all drugs and procedures available to the patient. The drugs list contains the tier or preferred list, step edits, and PA forms (13). All procedures (CPT) are listed with all specific requirements (17). The drugs or prescriptions can be prescribed (14) from the interface or PAs submitted (15). Once a PA is filed or prescription submitted, it goes to the physician/PA dashboard for patients and physicians to monitor insurance company response (16).

If a procedure or CPT code is entered (17), all procedural benefits are listed with protocols and PA forms. Also, all costs are published (18). The procedure can be scheduled (19) or PA forms submitted (20). The results are filed on the Physician/Patient dashboard (16).

If a specific drug or NDC number is entered (21), a list of the drug coverage is displayed including what tier or co-pay is needed (22). The drug can be prescribed (23) and sent to the pharmacy. If a PA is required, it is displayed and can be completed and submitted (24). The PA information or prescription submittal is sent to the physician/patient dashboard (16). The results of all adjudications and PAs are sent to the servers to compile the Live Benefits for each insurance company (8). The results are filed on the physician/patient dashboard (16).

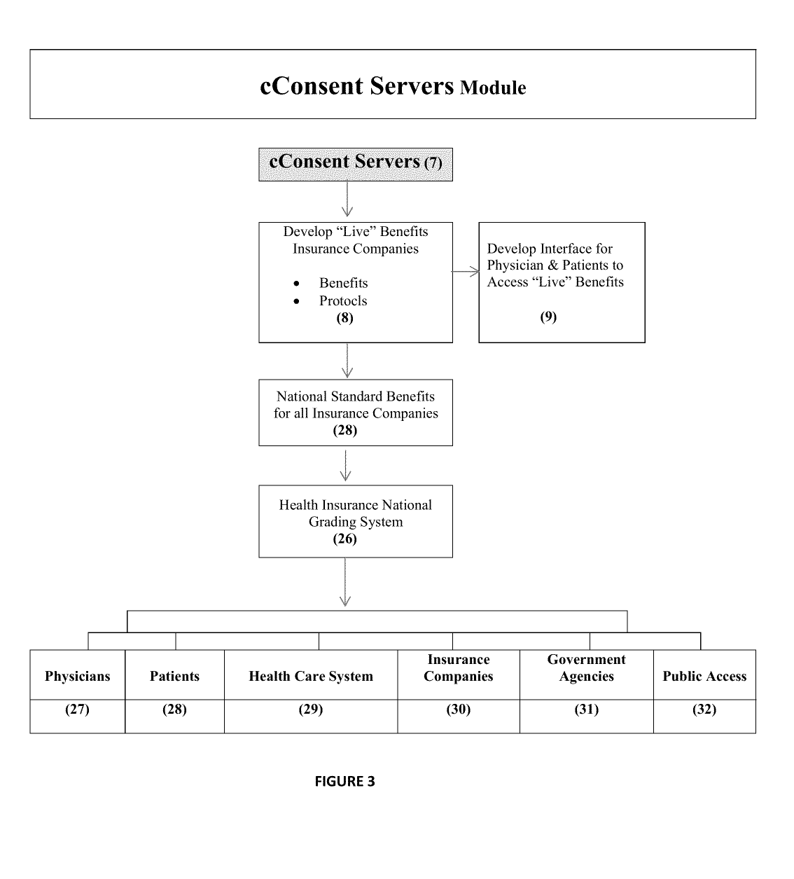

The servers may synthesize a national standard benefits list compiled from all insurance companies and claims in the nation (28) (FIG. 3). The national standard benefits list is used to compare each insurance company with a grading system (26). The grading system will generate a novel assessment tool comparing all health insurance companies, all patient interactions, and all adjudicated events including pharmacy and health benefits (26). Documenting ongoing patient/physician/insurance company interactions develops a verifiable picture of the Live Benefits provided by each insurance company. Several aspects are compared to receive an external grade of each insurance company. The system looks at Live Benefits versus published benefits, PBM formulary list and cost, step edit requirements, number of denials for benefits, and comparison of Live Benefits to the national standard benefits package, and a physician/patient assessment. The interface allows comparison of all parameters and ranks all insurance companies.

The Live Benefits of each insurance company, the national standard benefits package, and the grading of each insurance company is shared (FIG. 3) with all physicians (27), patients (28), health care systems (29), insurance companies (30), government agencies (31), and public access (32).

The insurance specific database enables physicians and patients to know what benefits the patients are entitled to, and the physician understands how to treat a patient based on the insurance company benefits (8). This posting enables daily recording of claims on the system server (7) to be left for public access (32) for the next patient and physician anywhere in the country, improving efficiency and fully disclosing the cost of prescriptions and health benefits to each patient prior to a prescription or healthcare need.

Physicians will use this information to prospectively discuss with patients the options for treatment and the cost (10) (FIG. 2). Additionally, the physician will understand how they will be reimbursed for each procedure. If there are insurance specific requirements for a certain procedure, such as a prior authorization, this information will be shared between physicians so that each time any physician in the country has a patient with the same insurance plan, he or she understands the process to obtain needed procedures for their patients. With this full disclosure of cost and availability of benefits, patients will be empowered to make financial decisions for care avoiding excessive medical bills, and the physician can efficiently order tests, procedures or prescribe medicines.

The system establishes a public access point (32) for patients and physicians to compare insurance companies' benefits (8). The system also has a grading system (26) to allow comparison of insurance benefits.

The system described with reference to FIG. 1-3 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:
the transfer protocol (e.g., http://); and
the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

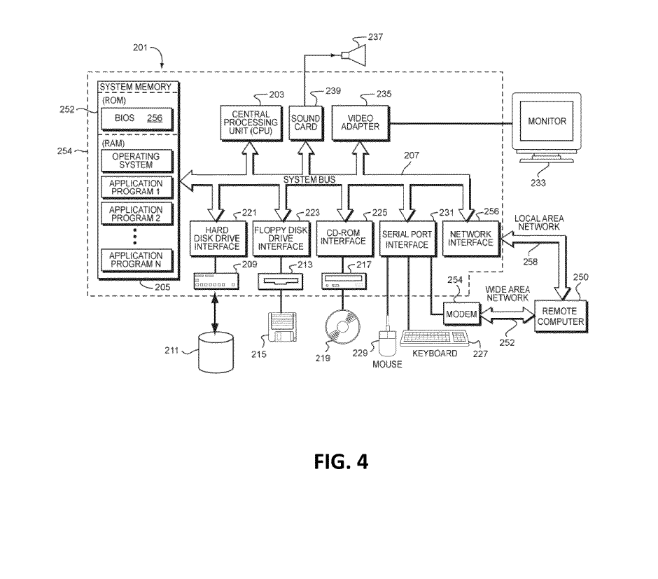

FIG. 4 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of documenting and sharing health insurance policy benefits comprising:
(a) documenting health claims to be adjudicated by health insurance companies;
(b) recording adjudication results of the health claims and storing the adjudication results on a system server;
(c) a processor organizing the adjudication results by health insurance company and by health insurance policy; and
(d) the system server publishing the organized adjudication results for public access over a global network.

2. A method according to claim 1, wherein step (a) is practiced by documenting medical procedure claims.

3. A method according to claim 1, wherein step (a) is practiced by documenting prescription claims.

4. A method according to claim 3, wherein step (c) is further practiced by organizing the adjudication results by ailment and by drug.

5. A method according to claim 1, wherein steps (a) and (b) are practiced by enabling patient members to input the health claims and the adjudication results to the system server over the global network.

6. A method according to claim 1, wherein steps (a) and (b) are practiced by enabling patients, physicians and the health insurance companies to input the health claims and the adjudication results to the system server over the global network.

7. A method according to claim 1, wherein step (b) is practiced by recording approval or denial of the medical claim, step edits, whether prior authorization was obtained, cost, protocols and formularies for prescriptions.

8. A method according to claim 1, further comprising storing a consumer grade for the health insurance companies and for the health insurance policies.

9. A collaboration website hosted by a server computer running a server program, the server computer executing the server program to perform the steps of:
(a) enabling individuals to input health claims adjudicated by health insurance companies;
(b) documenting the health claims and recording adjudication results of the health claims for storage on the server computer;
(c) a processor of the server computer organizing the adjudication results by health insurance company and by health insurance policy; and
(d) the server computer publishing the organized adjudication results for public access over a global network.

10. A collaboration website according to claim 9, wherein step (a) is practiced by documenting medical procedure claims.

11. A collaboration website according to claim 9, wherein step (a) is practiced by documenting medical prescription claims.

12. A collaboration website according to claim 11, wherein step (c) is further practiced by organizing the adjudication results by ailment and by drug.

13. A collaboration website according to claim 9, wherein steps (a) and (b) are practiced by enabling patient members to input the health claims and the adjudication results to the system server over the global network.

14. A collaboration website according to claim 9, wherein steps (a) and (b) are practiced by enabling patients, physicians and the health insurance companies to input the health claims and the adjudication results to the system server over the global network.

15. A collaboration website according to claim 9, wherein step (b) is practiced by recording approval or denial of the medical claim, step edits, whether prior authorization was obtained, cost, and formularies for prescriptions.

16. A collaboration website according to claim 9, wherein the server computer executes the server program to perform the step of storing a consumer grade for the health insurance companies and for the health insurance policies.

17. A computer system for documenting and sharing health insurance policy benefits, the system comprising:
a plurality of user computers each running a computer program that enables a patient to document health claims to be adjudicated by a health insurance company; and
a system server running a server program, the at least one user computer and the system server being interconnected by a computer network, the system server recording adjudication results of the health claims and storing the adjudication results, wherein the system server organizes the adjudication results by health insurance company and by health insurance policy, and wherein the system server publishes the organized adjudication results for public access over a global network.
